(19) United States
(12) Patent Application Publication
(10) Pub. No.: US 2010/0159234 A1
(43) Pub. Date: Jun. 24, 2010

(54) Adhesive film composition for electric and electronic devices and adhesive film using the same

(76) Inventors: Sang Sik Bae, Uiwang-si (KR); Kang Bae Yoon, Uiwang-si (KR); Kyoung Soo Park, Uiwang-si (KR); Kyoung Hun Shin, Uiwang-si (KR); Young Jin Kwon, Uiwang-si (KR)

Correspondence Address: LEE & MORSE, P.C., 3141 FAIRVIEW PARK DRIVE, SUITE 500, FALLS CHURCH, VA, 22042, US

(21) Appl. No.: 12/654,284

(22) Filed: Dec. 16, 2009

(30) Foreign Application Priority Data
Dec. 23, 2008 (KR) 10-2008-0132629

(51) Int. Cl. C08K 5/29; H01B 1/12; H01B 1/22; B32B 5/16

(52) U.S. Cl. 428/327; 524/195; 252/500; 252/511; 252/513; 252/514

(57) ABSTRACT

An adhesive film composition for electric and electronic devices and an adhesive film produced using the same, the composition including a binder, the binder including an ester linkage-containing resin, a carbodiimide group-containing compound, a (meth)acrylate group-containing compound; and an organic peroxide.

### 1. FIELD

Embodiments relate to an adhesive film composition for electric and electronic devices and an adhesive film using the same.

### 2. DESCRIPTION OF THE RELATED ART

In recent years, an on-board density of electronic components has increased with development of electronic devices. Further, new types of mounting methods have been employed, e.g., bare chip mounting of semiconductors, a semiconductor package called a chip scale package or chip size package (hereinafter, referred to as “CSP), and the like.

Reliability may be an important feature for a mounting substrate with various electronic components including semiconductor devices. In particular, connection reliability in the face of thermal fatigue may be very important since it may be directly related to reliability of devices employing the mounting substrate.

Thermal stress resulting from the use of various materials with different thermal expansion coefficients may be a main cause of reduced connection reliability. That is, since a semiconductor device may have a lower thermal expansion coefficient, e.g., about 4 ppm/° C., and a wiring board for mounting electronic components may have a higher thermal expansion coefficient, e.g., about 15 ppm/° C. or more, thermal impact may lead to thermal deformation, thereby causing thermal stress.

In a typical substrate that mounts a semiconductor package including a lead frame such as a QFP (quad flat package) or SOP (system-on-package), the lead frame may absorb thermal stress and maintain reliability.

However, in bare chip mounting, electrodes of a semiconductor device may be connected to wire pads of a wiring board via, e.g., soldering balls or small protrusions called bumps with adhesive pastes. In this case, connection reliability may be deteriorated due to concentration of thermal stress on connected regions. Although injection of an under-fill resin into a space between the semiconductor device and the wiring board may be effective in terms of distribution of the thermal stress, injecting the under-fill may increase a number of mounting processes and manufacturing costs. Further, in a method of connecting the electrodes of the semiconductor device to the wire pads of the wiring board using a conventional wire bonding technique, a sealing resin may be required to protect the wires, also increasing the number of mounting processes.

Since CSP may permit batch installation of semiconductor devices together with other electronic components, realization of CSP has been attempted by application of a tape or a carrier substrate to a wiring board known as an interposer. Techniques developed by, e.g., Tecera Co., Ltd. and TI Co., Ltd., may demonstrate excellent connection reliability.

### SUMMARY

Embodiments are directed to an adhesive film composition for electric and electronic devices and an adhesive film using the same, which substantially overcome one or more of the problems due to the limitations and disadvantages of the related art.

It is a feature of an embodiment to provide an adhesive film for electric and electronic devices, which may prevent hydrolysis of ester linkages caused by water or an acid catalyst in a high-temperature and high-humidity atmosphere, to provide stable adhesive strength and contact resistance, thereby ensuring high reliability.

At least one of the above and other features and advantages may be realized by providing an adhesive film composition for electric and electronic devices including a binder including an ester linkage-containing resin, a carbodiimide group-containing compound, a (meth)acrylate group-containing compound, and an organic peroxide.

The composition may include 100 parts by weight of the binder, about 0.1 to about 10 parts by weight of the carbodiimide group-containing compound, about 10 to about 120 parts by weight of the (meth)acrylate group-containing compound, and about 0.1 to about 10 parts by weight of the organic peroxide.

The binder may include a carboxyl group-modified acrylonitrile butadiene rubber, a (meth)acrylate-based copolymer, and a resin having ester linkages in a main chain thereof.

The binder may include, based on a total weight of the binder, about 3 to about 60 wt % of the carboxyl group-modified acrylonitrile butadiene rubber, about 5 to about 50 wt % of the (meth)acrylate-based copolymer, and about 5 to about 70 wt % of the resin having ester linkages in the main chain thereof.

The carboxyl group-modified acrylonitrile butadiene rubber may have a weight-average molecular weight of about 2,000 to about 300,000, the carboxyl group-modified acrylonitrile butadiene rubber may include about 10 to about 60 wt % acrylonitrile, based on a total weight of the carboxyl group-modified acrylonitrile butadiene rubber, and the carboxyl group-modified acrylonitrile butadiene rubber may include about 1 to about 20 wt % of a carboxyl group, based on a total weight of the carboxyl group-modified acrylonitrile butadiene rubber.

The (meth)acrylate-based copolymer may include a copolymer of at least one (meth)acrylate-based monomer, the (meth)acrylate-based monomer including at least one of hydroxyl group-containing (meth)acrylates, alkyl methyl(meth)acrylates, ethyl(meth)acrylates, propyl(meth)acrylates, butyl(meth)acrylates, hexyl(meth)acrylates, octyl(meth)acrylates, dodecyl(meth)acrylates, lauryl(meth)acrylates, (meth)acrylic acids, vinyl acetates, and derivatives thereof.

The (meth)acrylate-based copolymer may have a glass transition temperature (Tg) of about 50 to about 120° C. and an acid value of about 1 to about 100 mg KOH/g.

The resin having ester linkages in the main chain thereof may include at least one of a polyester resin, an ester type urethane resin, a (meth)acrylate-modified urethane resin, and a reactive acrylate resin.

The carbodiimide group-containing compound may have a weight-average molecular weight of about 200 to about 600 and is represented by the following Chemical Formula 1:

R—N═C═N—R (1),

wherein each R is independently a C₁₋₆ straight or branched alkyl group, a C₅₋₁₀ chain type alkyl group, a C₆₋₂₀ aryl group, or a C₆₋₂₀ aralkyl group.

The (meth)acrylate group-containing compound may include at least one of a (meth)acrylate oligomer and a (meth)acrylate monomer.

The (meth)acrylate group-containing compound may include the (meth)acrylate oligomer, the (meth)acrylate oligomer including at least one of urethane-based (meth)acrylate oligomers, epoxy-based (meth)acrylate oligomers, polyester-based (meth)acrylate oligomers, fluorine-based (meth)acrylate oligomers, fluorene-based (meth)acrylate oligomers, silicone-based (meth)acrylate oligomers, phosphoric acid-based (meth)acrylate oligomers, maleimide-modified (meth)acrylate oligomers, and acrylate(meth)acrylate oligomers.

The (meth)acrylate group-containing compound may include the (meth)acrylate monomer, the (meth)acrylate monomer including at least one of hydroxyl group-containing (meth)acrylates, C₁₋₂₀ straight alkyl (meth)acrylates, C₁₋₂₀ branched alkyl (meth)acrylates, C₆₋₂₀ aryl (meth)acrylates, C₆₋₂₀ arylalkyl (meth)acrylates, C₆₋₂₀ cycloalkyl-containing (meth)acrylates, polycyclic (meth)acrylates, heterocyclic (meth)acrylates, ether group-containing (meth)acrylates, epoxy group-containing (meth)acrylates, aryloxy group-containing (meth)acrylates, alkyleneglycol(meth)acrylates, bisphenol-A di(meth)acrylates, fluorene-based (meth)acrylates, and acid phosphoxy ethyl(meth)acrylates.

The (meth)acrylate group-containing compound may include at least one of a fluorene-based epoxy(meth)acrylate and a fluorene-based urethane(meth)acrylate, the at least one fluorene-based epoxy(meth)acrylate and fluorene-based urethane(meth)acrylate being obtained from a fluorene derivative represented by the following Chemical Formula 2:

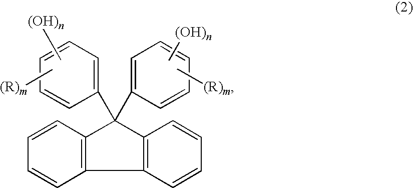

wherein each R is independently an alkyl group, an alkoxy group, an aryl group, or a cyclo-alkyl group, m is an integer of 0 to about 4, and n is an integer of about 2 to about 5

The adhesive may further include about 0.1 to about 20 parts by weight of conductive particles with respect to 100 parts by weight of the binder.

The conductive particles may include at least one of metallic particles including at least one of Au, Ag, Ni, Cu, and Pb, carbon particles, metal-coated polymer resin particles, and surface insulation-treated particles prepared through insulation treatment on a surface of a metal-coated polymer resin particle.

The adhesive film composition may have a 90-degree adhesive force, after a pressing condition of 180° C., 4 seconds, 3.5 MPa, of about 800 to about 980 gf/cm² at 85° C., a relative humidity of 85%, and 500 hours.

At least one of the above and other features and advantages may also be realized by providing an adhesive film produced using the adhesive film composition of an embodiment.

### DETAILED DESCRIPTION

Korean Patent Application No. 10-2008-0132629, filed on Dec. 23, 2008, in the Korean Intellectual Property Office, and entitled: “Adhesive Film Composition for Electric and Electronic Devices and Adhesive Film Using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when an element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

A adhesive film composition of an embodiment may include (a) a binder including an ester linkage-containing resin, (b) a carbodiimide group-containing compound, (c) a (meth)acrylate group-containing compound, and (d) an organic peroxide.

Binder

The binder may include the ester linkage-containing resin. In an implementation, the binder may include (i) a carboxyl group-modified acrylonitrile butadiene rubber, (ii) a (meth)acrylate-based copolymer, and (iii) a resin having ester linkages in a main chain thereof.

(i) Carboxyl Group-Modified Acrylonitrile Butadiene Rubber

The carboxyl group-modified acrylonitrile butadiene rubber may, e.g., enhance stability of a resin mixture via a carboxyl group present therein. The carboxyl group may enhance not only miscibility with other resins and additives, but also formability and coating properties. Furthermore, the carboxyl group may enhance an adhesive force, through an increase in polarity, as well as other physical properties, e.g., moisture resistance, heat resistance, and the like.

The carboxyl group-modified acrylonitrile butadiene rubber may have a weight-average molecular weight of about 2,000 to about 300,000. Maintaining the weight-average molecular weight of the carboxyl group-modified acrylonitrile butadiene rubber at about 2,000 or greater may help ensure that thermal stability is not deteriorated. Maintaining the weight-average molecular weight of the carboxyl group-modified acrylonitrile butadiene rubber at about 300,000 or less may help ensure that solvent solubility is not deteriorated and viscosity is not increased during preparation of a solution, thereby ensuring workability and adhesion. In an implementation, the carboxyl group-modified acrylonitrile butadiene rubber may have a weight-average molecular weight of about 100,000 to about 250,000. In another implementation, the carboxyl group-modified acrylonitrile butadiene rubber may have a weight-average molecular weight of about 2,000 about 10,000.

The carboxyl group-modified acrylonitrile butadiene rubber may include about 10 to about 60 wt % acrylonitrile, based on the weight of the carboxyl group-modified acrylonitrile butadiene rubber. Maintaining the amount of acrylonitrile at about 10 wt % or greater may help ensure that solvent solubility is not lowered. Maintaining the amount of acrylonitrile at about 60 wt % or less may help ensure that electrical insulation properties are not deteriorated. Preferably, the carboxyl group-modified acrylonitrile butadiene rubber includes about 20 to about 50 wt % acrylonitrile.

The carboxyl group-modified acrylonitrile butadiene rubber may include about 1 to about 20 wt % of the carboxyl group, based on the weight of the carboxyl group-modified acrylonitrile butadiene rubber. Maintaining the amount of the carboxyl group at about 1 to about 20 wt % may help ensure that the carboxyl group-modified acrylonitrile butadiene rubber can be easily coupled to other resins and adhesive components, thereby improving an adhesive force. In an implementation, the carboxyl group-modified acrylonitrile butadiene rubber may include about 5 to about 10 wt % of the carboxyl group.

The carboxyl group-modified acrylonitrile butadiene rubber may be easily obtained in the art without any limitation. Commercially available examples of the carboxyl group-modified acrylonitrile butadiene rubber may include Vamac MR, Vamac Ultra IP, VMX30380, etc., (E.I. Du Pont de Nemours and Company, U.S.A.), and Nipol N34, 1072, 1072CGX, etc., (Zeon Co., Ltd., Japan).

The carboxyl group-modified acrylonitrile butadiene rubber may be included in the binder in an amount of about 3 to about 60 wt %, based on the weight of the binder. Maintaining the amount of carboxyl group-modified acrylonitrile butadiene rubber at about 3 wt % or greater may help ensure that an adhesive force with respect to a target is not lowered. Maintaining the amount of carboxyl group-modified acrylonitrile butadiene rubber at about 60 wt % or less may help ensure that resin fluidity is not deteriorated during thermal compression due to a high molecular weight. In an implementation, the binder may include about 3 to about 40 wt % of the carboxyl group-modified acrylonitrile butadiene rubber. In another implementation, the binder may include about 5 to about 20 wt % of the carboxyl group-modified acrylonitrile butadiene rubber.

(ii) (Meth)Acrylate-Based Copolymer

The (meth)acrylate-based copolymer may include copolymers of at least one (meth)acrylate-based monomer. The (meth)acrylate-based monomer may include, e.g., C₁₋₂₀ alkyl (meth)acrylates, hydroxyl group-containing (meth)acrylates, (meth)acrylic acids, vinyl acetates, and/or derivatives thereof.

The C₁₋₂₀ alkyl (meth)acrylate may include, e.g., methyl (meth)acrylates, ethyl(meth)acrylates, propyl(meth)acrylates, butyl(meth)acrylates, hexyl(meth)acrylates, octyl(meth)acrylates, dodecyl(meth)acrylates, lauryl(meth)acrylates, (meth)acrylic acids, vinyl acetates, and/or derivatives thereof.

The (meth)acrylate-based copolymer may have a glass transition temperature (Tg) of about 50 to about 120° C. Maintaining the Tg of the (meth)acrylate-based copolymer at about 50° C. or higher may help ensure that the film does not become soft, thereby ensuring sufficient compressibility and connection reliability together with urethane acrylate having a low Tg. Maintaining the Tg of the (meth)acrylate-based copolymer at about 120° C. or lower may help ensure that the adhesive film is not broken, thereby ensuring ease of forming the film. Preferably, the Tg is about 60 to about 100° C. More preferably, the Tg is about 65 to about 95° C.

In an implementation, the (meth)acrylate-based copolymer may further include an epoxy group or an alkyl group. The (meth)acrylate-based copolymer may have an acid value of about 1 to about 100 mg KOH/g. Maintaining the acid value of the (meth)acrylate-based copolymer at about 1 mg KOH/g or greater may help ensure that a sufficient adhesive force is obtained. Maintaining the acid value of the (meth)acrylate-based copolymer at about 100 mg KOH/g or less may help ensure that connection reliability is not deteriorated by corrosion. Preferably, the (meth)acrylate-based copolymer has an acid value of about 1.5 to about 50 mg KOH/g. More preferably, the (meth)acrylate-based copolymer has an acid value of about 2 to about 20 mg KOH/g. Still more preferably, the (meth)acrylate-based copolymer has an acid value of about 2.5 to about 10 mg KOH/g.

In particular, the (meth)acrylate-based copolymer may have a Tg of about 70 to about 80° C. and an acid value of about 2.5 to about 6 mg KOH/g to realize strong film characteristics.

The (meth)acrylate-based copolymer may have a weight-average molecular weight of about 10,000 to about 300,000. Preferably, the (meth)acrylate-based copolymer has a weight-average molecular weight of about 50,000 to about 150,000.

The (meth)acrylate-based copolymer may be included in the binder in an amount of about 5 to about 50 wt %, based on the weight of the binder. Maintaining the amount of the (meth)acrylate-based copolymer at about 5 wt % or greater may help ensure that the film is able to be formed. Maintaining the amount of the (meth)acrylate-based copolymer at about 50 wt % or less may help ensure that tacticity of the film is not deteriorated, that bonding of the film may be achieved, and resin fluidity is not deteriorated during thermal compression. In an implementation, the (meth)acrylate-based copolymer may be included in the binder in an amount of about 5 to about 40 wt %. In another implementation, the (meth)acrylate-based copolymer may be included in the binder in an amount of about 10 to about 30 wt %.

(iii) Resin Having Ester Linkages in the Main Chain

Any suitable resin having ester linkages in the main chain may be used. The resin having ester linkages in the main chain may include, e.g., a polyester resin, an ester type urethane resin, a (meth)acrylate-modified urethane resin, and/or a reactive acrylate resin.

Commercially available examples of the polyester resin may include EB810 (available from SK Cytec Co., Ltd., Korea), UE3500 and UE9200 (Unitica Co. Ltd., Japan), and the like. Commercially available examples of the ester type urethane resin may include KUB2006 and KUB2007 (Gangnam Chemical Co., Ltd., Korea), and D-ACE (Donsung Chemical Co., Ltd., Korea) Commercially available examples of the (meth)acrylate-modified urethane resin may include UA512 (Shin-Nakamura Co. Ltd., Japan), AT600 (Kyoeisha Co., Ltd., Japan), UN7600 (Negami kougyo Co., Ltd., Japan), and the like.

The (meth)acrylate-modified urethane resin including the ester linkage may be synthesized by, e.g., a polyaddition reaction of an ester linkage-containing polyol to a hydroxyl group-containing (meth)acrylate and isocyanate. The polyaddition reaction may be carried out in a solvent using a catalyst.

The ester linkage-containing polyol may be obtained by, e.g., condensation of a dicarboxylic acid compound and a diol compound. The dicarboxylic acid compound may include, e.g., succinic acid, glutaric acid, isophthalic acid, adipic acid, suberic acid, azelaic acid, sebacic acid, dodecanedionic acid, hexahydrophthalic acid, isophthalic acid, terephthalic acid, ortho-phthalic acid, tetrachlorophthalic acid, 1,5-naphthalenedicarboxylic acid, fumaric acid, maleic acid, itaconic acid, citraconic acid, mesaconic acid, and/or tetrahydrophthalic acid. The diol compound may include, e.g., ethylene glycol, propylene glycol, 1,3-propanediol, 1,3-butanediol, 1,4-butanediol, 1,5-pentanediol, 1,6-hexanediol, neopentyl glycol, diethylene glycol, dipropylene glycol, triethylene glycol, tetraethylene glycol, dibutylene glycol, 2-methyl-1,3-pentanediol, 2,2,4-trimethyl-1,3-pentanediol, and/or 1,4-cyclohexanemethanol. In an implementation, a polyether polyol, e.g., polyethylene glycol, polypropylene glycol, polytetraethylene glycol, and the like, may be used.

The ester linkage-containing polyol prepared by the condensation of the dicarboxylic acid compound and the diol compound may have a weight-average molecular weight of about 400 to about 10,000. In an implementation, the ester linkage-containing polyol may have a weight-average molecular weight of about 400 to about 3,000.

The hydroxyl group-containing (meth)acrylate may include, e.g., hydroxyethyl acrylate, hydroxyethyl methacrylate, and the like.

The isocyanate may include, e.g., aliphatic diisocyanates, such as tetramethylene diisocyanate, hexamethylene diisocyanate, trimethylhexamethylene diisocyanate; alicyclic diisocyanates, such as 4,4′-methylene-bis(cyclohexyl isocyanate), isophorone diisocyanate, and the like; and aromatic diisocyanates, such as xylene diisocyanate, toluene diisocyanate, phenylene diisocyanate, 3,3′-dimethyl-4,4′-biphenylene diisocyanate, naphthalene-1,5-diisocyanate, diphenylmethane diisocyanate, polyphenylmethane diisocyanate, and the like.

The (meth)acrylate-modified urethane resin including the ester linkage may be prepared by, e.g., reacting about 2 mol isocyanate with about 1 mol of the polyol, followed by reacting the hydroxyl group-containing (meth)acrylate with about 1 mol of the reactant.

In an implementation, the (meth)acrylate-modified urethane resin may have a weight-average molecular weight of about 800 to about 200,000. In another implementation, the (meth)acrylate-modified urethane resin may have a weight-average molecular weight of about 1,000 to about 100,000.

The resin having ester linkages in the main chain may be included in the binder in an amount of about 5 to about 70 wt %, based on the weight of the binder. Maintaining the amount of the resin having ester linkages in the main chain at about 5 wt % or greater may help ensure a sufficient adhesive force and ease of film formation. Maintaining the amount of the resin having ester linkages in the main chain at about 70 wt % or less may help ensure that the resin fluidity is not deteriorated during thermal compression. Preferably, the resin having ester linkages in the main chain is included in the binder in an amount of about 20 to about 65 wt %. More preferably, the resin having ester linkages in the main chain is included in the binder in an amount of about 45 to about 60 wt %.

(b) Carbodiimide Group-Containing Compound

In an implementation, the carbodiimide group-containing compound may be represented by the following Chemical Formula 1:

R—N═C═N—R (1).

In Chemical Formula 1, each R may independently be a C₁₋₆ straight or branched alkyl group, a C₅₋₁₀ chain type alkyl group, a C₆₋₂₀ aryl group, or a C₆₋₂₀ aralkyl group.

In an implementation, each R may independently be a 1,3-isopropyl group, a 1,3-cyclohexyl group, or a 2,2′,6,6′-tetraisopropylphenyl group.

The carbodiimide group-containing compound may include, e.g., 1,3-diisopropyl carbodiimide, 1,3-dicyclohexyl carbodiimide, 2,2,6,6′-tetraisopropylphenyl carbodiimide, and the like. These compounds may be used either alone or in combination.

Commercially available examples of the carbodiimide group-containing compounds may include Stabaxol P200 (Rhein Chemie Co., Ltd., Germany), and carbodilite series V-02, V-02-L2, V-04, E-01, and E-02 (Nisshinbo Industries, Inc., Japan)

When a binder includes ester linkages, hydrolysis of ester linkages may occur by water and an acid catalyst in a high-temperature and high-humidity atmosphere. However, in the composition of an embodiment, water and the acid catalyst may be removed from the binder by the carbodiimide group-containing compound, thereby efficiently preventing hydrolysis of the ester linkages.

A reaction of removing water and the acid catalyst by the carbodiimide group-containing compound may be represented by, e.g., the following Reactions 1 and 2:

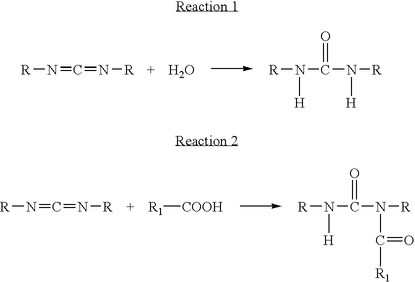

The carbodiimide group-containing compound may be stable at room temperature and may be active at high-temperature and high-humidity conditions. Thus, when included in the ester linkage-containing binder in preparation of the adhesive film composition for electric and electronic devices, the carbodiimide group-containing compound may efficiently remove water and acids to prevent the hydrolysis of the ester linkage, while supplying stable adhesive force and connection resistance, thereby further improving reliability of the adhesive film.

The carbodiimide group-containing compound may have a weight-average molecular weight of about 200 to about 600. Maintaining the weight-average molecular weight of the carbodiimide group-containing compound at about 200 or greater may help ensure that the reaction of the carbodiimide group-containing compound does not proceed too quickly, advantageously avoiding a curing reaction during fabrication of the adhesive film. Maintaining the weight-average molecular weight at about 600 or less may help ensure that the reaction of the carbodiimide group-containing compound does not proceed too slowly, beneficially preventing the hydrolysis of the ester linkage.

The carbodiimide group-containing compound may be included in the composition in an amount of about 0.1 to about 10 parts by weight with respect to 100 parts by weight of the binder. Maintaining the amount of carbodiimide group-containing compound at about 0.1 parts by weight or greater may help ensure that the amount of carbodiimide group-containing compound is not too small to effectively prevent the hydrolysis of the ester group. Maintaining the amount of carbodiimide group-containing compound at about 10 parts by weight or less may help ensure that an excess portion of the carbodiimide group-containing compound not participating in an initiation reaction of peroxide does not form bubbles during thermal compression. In an implementation, the carbodiimide group-containing compound may be included in an amount of about 0.1 to about 4.5 parts by weight. In another implementation, the carbodiimide group-containing compound may be included in an amount of about 5 to about 10 parts by weight.

(c) (Meth)Acrylate Group-Containing Compound

The (meth)acrylate group-containing compound may be, e.g., a material obtained through radical polymerization. The (meth)acrylate group-containing compound may be included in the adhesive film composition to, e.g., ensure adhesive strength and connection reliability between connection layers by a radical curing reaction.

The (meth)acrylate group-containing compound may include a (meth)acrylate oligomer, a (meth)acrylate monomer, or the like.

The (meth)acrylate oligomer may include, e.g., a typical (meth)acrylate oligomer. The (meth)acrylate oligomer may have a weight-average molecular weight of about 1,000 to about 100,000. Preferably, the weight-average molecular weight is about 1,000 to about 50,000.

In an implementation, the (meth)acrylate oligomer may include, e.g., urethane-based (meth)acrylate oligomers, epoxy-based (meth)acrylate oligomers, polyester-based (meth)acrylate oligomers, fluorine-based (meth)acrylate oligomers, fluorene-based (meth)acrylate oligomers, silicone-based (meth)acrylate oligomers, phosphoric acid-based (meth)acrylate oligomers, maleimide-modified (meth)acrylate oligomers, and/or acrylate (meth)acrylate oligomers.

The urethane-based (meth)acrylate oligomer may have intermediate molecular structures synthesized from, e.g., a polyol and at least one of 2,4-toluene diisocyanate, 1,3-xylene diisocyanate, 1,4-xylene diisocyanate, 1,5-naphthalene diisocyanate, 1,6-hexane diisocyanate, isophorone diisocyanate, bisphenol A propyleneoxide-modified diacrylate, etc. The polyol may include, e.g., polyether polyol, polycarbonate polyol, polycarprolactone polyol, tetrahydrofurane-propyleneoxide ring opening copolymer, polybutadiene diol, polydimethylsiloxane diol, ethylene glycol, propylene glycol, 1,4-butanediol, 1,5-pentanediol, 1,6-hexanediol, neopentyl glycol, 1,4-cyclohexane dimethanol, bisphenol A, hydrogenated bisphenol A, etc.

The epoxy-based (meth)acrylate oligomer may have an intermediate molecular structure that includes a backbone including, e.g., 2-bromohydroquinone, resorcinol, catechol, bisphenols such as bisphenol A, bisphenol F, bisphenol AD, and bisphenol S, 4,4′-dihydroxybiphenyl, and/or bis(4-hydroxyphenyl)ether. The backbone of the epoxy-based (meth)acrylate oligomer may include a substituent including, e.g., an alkyl group, an aryl group, a methylol group, an allyl group, a cyclic aliphatic group, halogens (tetrabromobisphenol A and the like), a nitro group, and the like.

In an implementation, the (meth)acrylate oligomer may include at least two maleimide groups in the molecule thereof. In particular, the (meth)acrylate oligomer may include, e.g., 1-methyl-2,4-bis(maleimide) benzene, N,N′-m-phenylenebis(maleimide), N,N′-p-phenylenebis(maleimide), N,N′-m-tolylenebis(maleimide), N,N′-4,4-biphenylenebis(maleimide), N,N′-4,4-(3,3′-dimethyl-biphenylene)bis(maleimide), N,N′-4,4-(3,3′-dimethyldiphenylmethane)bis(maleimide), N,N′-4,4-(3,3′-diethyldiphenylmethane)bis(maleimide), N,N′-4,4-diphenylmethanebis(maleimide), N,N′-4,4-diphenylpropanebis(maleimide), N,N′-4,4-diphenyletherbis(maleimide), N,N′-3,3′-diphenylsulfonebis(maleimide), 2,2-bis[4-(4-maleimidophenoxy)phenyl]propane, 2,2-bis[3-s-butyl-4-(4-maleimidophenoxy)phenyl]propane, 1,1-bis[4-(4-maleimidophenoxy)phenyl]decane, 4,4′-cyclohexylidenebis[1-(4-maleimidophenoxy)-2-cyclohexylbenzene, and 2,2-bis[4-(4-maleimidphenoxy)phenyl]hexafluoropropane. Any of these may be used either alone or in combination.

The (meth)acrylate group-containing compound may include, e.g., a fluorene-based (meth)acrylate obtained from fluorene derivatives represented by the following Chemical Formula 2:

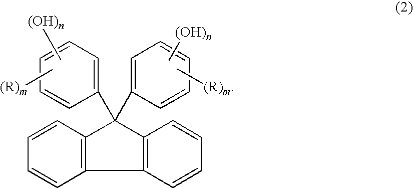

In Chemical Formula 2, each R may independently be, e.g., an alkyl group, an alkoxy group, an aryl group, or a cycloalkyl group, m may be an integer of 0 to about 4, and n may be an integer of about 2 to about 5.

In other words, the (meth)acrylate group-containing compound may include a fluorene moiety having a structure represented by Chemical Formula 2. In the fluorene moiety having the structure represented by Chemical Formula 2, R may be an alkyl, alkoxy, aryl or cycloalkyl group, m may be an integer of 0 to about 4, and n may be an integer of about 2 to about 5. In an implementation, m may be an integer of 0 to about 3. In another implementation, n may be an integer of about 1 to about 5. For example, m may be 0, 1, 2, 3, or 4 and n may be 1, 2, 3, 4, or 5.

The fluorene-based (meth)acrylate group may include, e.g., fluorene-based epoxy (meth)acrylates and/or fluorene-based urethane (meth)acrylates.

Including the fluorene-based epoxy (meth)acrylate in the binder may, e.g., decrease possibility of short circuits and may ensure low connection resistance as well as high reliability at initial time due to superior insulation properties of the fluorene structure, thereby improving productivity and reliability of final products.

The (meth)acrylate monomer may include, e.g., hydroxyl group-containing (meth)acrylates, C₁₋₂₀ straight alkyl(meth)acrylates, C₁₋₂₀ branched alkyl (meth)acrylates, C₆₋₂₀ aryl(meth)acrylates, C₆₋₂₀ arylalkyl(meth)acrylates, C₆₋₂₀ cycloalkyl-containing (meth)acrylates, polycyclic(meth)acrylates, heterocyclic(meth)acrylates, ether group-containing (meth)acrylates, epoxy group-containing (meth)acrylates, aryloxy group-containing (meth)acrylates, alkyleneglycol (meth)acrylates, bisphenol-A di(meth)acrylates, fluorene-based (meth)acrylates, and/or acid phosphoxy ethyl(meth)acrylates.

In an implementation, the (meth)acrylate monomer may include, e.g., 1,6-hexanediol mono(meth)acrylate, 2-hydroxyethyl(meth)acrylate, 2-hydroxypropyl(meth)acrylate, 2-hydroxybutyl(meth)acrylate, 2-hydroxy-3-phenyloxypropyl(meth)acrylate, 1,4-butanediol(meth)acrylate, 2-hydroxyalkyl(meth)acryloylphosphate, 4-hydroxy cyclohexyl(meth)acrylate, neopentylglycol mono(meth)acrylate, trimethylolethane di(meth)acrylate, trimethylolpropane di(meth)acrylate, pentaerythritol tri(meth)acrylate, dipentaerythritol penta(meth)acrylate, pentaerythritol hexa(meth)acrylate, dipentaerythritol hexa(meth)acrylate, glycerin di(meth)acrylate, t-hydrofurfuryl (meth)acrylate, isodecyl(meth)acrylate, 2-(2-ethoxyethoxy)ethyl(meth)acrylate, stearyl(meth)acrylate, lauryl(meth)acrylate, 2-phenoxyethyl(meth)acrylate, isobornyl(meth)acrylate, tridecyl(meth)acrylate, ethoxylated nonylphenol(meth)acrylate, ethyleneglycol di(meth)acrylate, diethyleneglycol di(meth)acrylate, triethyleneglycol di(meth)acrylate, t-ethyleneglycol di(meth)acrylate, polyethyleneglycol di(meth)acrylate, 1,3-butyleneglycol di(meth)acrylate, tripropyleneglycol di(meth)acrylate, ethoxylated bisphenol-A di(meth)acrylate, cyclohexanedimethanol di(meth)acrylate, phenoxy-t-glycol di(meth)acrylate, 2-methacryloyloxyethyl phosphate, dimethyloltricyclodecane di(meth)acrylate, trimethylolpropanebenzoate acrylate, fluorene-based (meth)acrylates, acid phosphoxy ethyl(meth)acrylate, and the like.

The (meth)acrylate monomer may include at least one fluorene-based (meth)acrylate monomer having a backbone represented by Chemical Formula 2. Examples of the fluorene-based (meth)acrylate monomer include a fluorene-based epoxy (meth)acrylate monomer, a fluorene-based urethane (meth)acrylate monomer, and the like, which are well known in the art. A commercially available example of the fluorene-based (meth)acrylate monomer may include BPEFA (Osaka Gas Co., Ltd., Japan).

The (meth)acrylate group-containing compound may be included in an amount of about 10 to about 120 parts by weight with respect to 100 parts by weight of the binder. Maintaining the amount at about 10 parts by weight or greater may help ensure that the amount of acrylate participating in the initiation reaction is not too small, advantageously maintaining physical properties of the film after reliability testing. Maintaining the amount at about 120 parts by weight or less may help ensure that not too much acrylate having a low molecular weight is present, easing film formation. In an implementation, the (meth)acrylate group-containing compound may be included in an amount of about 50 to about 100 parts by weight. In another implementation, the (meth)acrylate group-containing compound may be included in an amount of about 10 to about 40 parts by weight.

(d) Organic Peroxide

The organic peroxide may be used as a polymerization initiator and may serve as a curing agent that generates organic radicals by heat or light.

The organic peroxide may include, e.g., t-butylperoxy laurate, 1,1,3,3-t-methylbutyl peroxy-2-ethylhexanoate, 2,5-dimethyl-2,5-di(2-ethylhexanoylperoxy)hexane, 1-cyclohexyl-1-methylethylperoxy-2-ethylhexanoate, 2,5-dimethyl-2,5-di(m-toluoylperoxy)hexane, t-butyl peroxyisopropyl monocarbonate, t-butylperoxy-2-ethylhexylmonocarbonate, t-hexylperoxybenzoate, t-butylperoxyacetate, dicumyl peroxide, 2,5-dimethyl-2,5-di(t-butylperoxy)hexane, t-butylcumyl peroxide, t-hexylperoxyneodecanoate, t-hexylperoxy-2-ethylhexanoate, t-butylperoxy-2-2-ethylhexanoate, t-butylperoxyisobutyrate, 1,1-bis(t-butylperoxy)cyclohexane, t-hexylperoxy isopropylmonocarbonate, t-butylperoxy-3,5,5-trimethylhexanoate, t-butylperoxypivalate, cumylperoxyneodecanoate, di-isopropylbenzene hydroperoxide, cumene hydroperoxide, isobutylperoxide, 2,4-dichlorobenzoyl peroxide, 3,5,5-trimethylhexanoyl peroxide, octanoylperoxide, lauroylperoxide, stearoylperoxide, succinic peroxide, benzoylperoxide, 3,5,5-trimethylhexanoyl peroxide, benzoyl peroxytoluene, 1,1,3,3-tetramethylbutylperoxy neodecanoate, 1-cyclohexyl-1-methylethylperoxyneodecanoate, di-n-propylperoxy dicarbonate, di-isopropylperoxy dicarbonate, bis(4-t-butylcyclohexyl)peroxy dicarbonate, di-2-ethoxymethoxyperoxy dicarbonate, di(2-ethylhexylperoxy)dicarbonate, dimethoxybutylperoxy dicarbonate, di(3-methyl-3-methoxybutylperoxy)dicarbonate, 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-(t-butylperoxy)cyclododecane, 2,2-bis(t-butylperoxy)decane, t-butyltrimethylsilyl peroxide, bis(t-butyl)dimethylsilyl peroxide, t-butyltriallylsilyl peroxide, bis(t-butyl)diallylsilyl peroxide, tris(t-butyl)allylsilyl peroxide, and the like. The organic peroxides may be used either alone or in combination. Preferably, at least two peroxides are used in combination.

The organic peroxide may have e.g., a half-life temperature of about 5 hours to about 15 hours at about 40 to about 100° C. may be used. Maintaining a high half-life temperature that is not too low may help ensure that the decomposition rate does not cause difficulties in storage at normal temperature. Maintaining a half-life temperature that is not too high may help ensure that a polymerization rate is not too slow, thus ensuring quick curing.

The organic peroxide may be included in an amount of about 0.1 to about 10 parts by weight with respect to 100 parts by weight of the binder. Maintaining the amount of organic peroxide at about 0.1 parts by weight or greater may help ensure that initiation efficiency by the organic peroxide is not lowered, advantageously avoiding deterioration of physical properties after reliability testing. Maintaining the amount of organic peroxide at about 100 parts by weight or less may help ensure that the reaction speed is not excessively increased due to an excess amount of initiator, beneficially avoiding curing of the film before sufficient thermal compression and deterioration of physical properties. In an implementation, the organic peroxide may be included in an amount of about 1 to about 5 parts by weight. In another implementation, the organic peroxide may be included in an amount of about 6 to about 10 parts by weight.

In an implementation, the composition may include, e.g., 100 parts by weight of the binder including the ester linkage-containing resin, about 0.1 to about 4.5 parts by weight of the carbodiimide group-containing compound, about 50 to about 100 parts by weight of the (meth)acrylate group-containing compound, and about 1 to about 5 parts by weight of the organic peroxide. In another implementation, the composition may include, e.g., 100 parts by weight of the binder including the ester linkage-containing resin, about 5 to about 10 parts by weight of the carbodiimide group-containing compound, about 50 to about 100 parts by weight of the (meth)acrylate group-containing compound, and about 1 to about 5 parts by weight of the organic peroxide.

(e) Conductive Particles

The adhesive film composition for electric and electronic devices may further include conductive particles. The conductive particles may be used as fillers to impart conductivity to the adhesive film composition.

The conductive particles may include any suitable conductive particle known in the art. The conductive particles may include, e.g., metallic particles including at least one of Au, Ag, Ni, Cu, and Pb; carbon particles; metal-coated polymer resin particles; and surface insulation-treated particle prepared through insulation treatment of a surface of a metal-coated polymer resin particle. In other words, the metal may be further coated with frangible insulating material. Further, the frangible insulating material may be removed from the metal.

The carbon particles may include, e.g., carbon black, graphite, activated carbon, carbon whiskers, fullerenes, carbon nanotubes, and the like.

The polymer resin may include, e.g., polyethylene, polypropylene, polyester, polystyrene, polyvinyl alcohol, and the like.

The metal coated on the polymer resin may include, e.g., Au, Ag, and Ni.

The size of the conductive particle may correspond to a pitch between applied circuits. In an implementation, the conductive particles may have a particle size of about 2 to about 30 μm, depending on the use of the adhesive film.

The conductive particles may be included in an amount of about 0.1 to about 20 parts by weight with respect to 100 parts by weight of the binder. Maintaining the amount of conductive particles at about 0.1 parts by weight or greater may help ensure that stable connection reliability is achieved. Maintaining the amount of conductive particles at about 20 parts by weight or less may help ensure that the conductive particles do not agglomerate in the pitch between the circuits during thermal compression, advantageously avoiding an electric short circuit. In an implementation, if the adhesive film is used as an anisotropic conductive film, the film composition may include about 0.5 to about 10 parts by weight of the conductive particles.

The adhesive film composition according to an embodiment may be used to form not only a film type adhesive layer of an adhesive film used for a semiconductor process, but also a paste type bonding agent.

According to an embodiment, an adhesive film may include, e.g., a base film and at least one adhesive layer formed on one or both sides of the base film and made of the adhesive film composition as described above.

The adhesive film may include the adhesive layer formed on at least one side of the base film, e.g., a peelable film, an insulation film, a peelable paper sheet, etc., and made of the adhesive film composition of an embodiment. The adhesive film may further include another film to have a multilayer structure.

A material for the peelable film and the insulation film may include, e.g., polyesters such as polyethylene terephthalate; polyolefins such as polyethylene; polyimide; polyamide; polyether sulfone; polyphenylene sulfide; polyether ketone; triacetyl cellulose, and the like.

In particular, the peelable film may produced by, e.g., delaminating a film made of the material described above using a releasing agent such as silicone and the like.

The adhesive film composition, which may be applied to the base film to form the adhesive layer, has been described above, and a repeated description thereof is omitted.

Such an adhesive film may be produced by a technique well known in the art. For example, an adhesive film composition according to an embodiment may be dissolved and dispersed in an organic solvent to prepare an adhesive paint. The adhesive paint may be applied to one or both sides of a base film as described above to form an adhesive layer on the base film. The adhesive layer may be kept in a semi-cured state to suppress a void or fluidity during thermal compression of the adhesive layer. After drying the adhesive layer, the adhesive film may have a thickness of about 3 to about 200 μm. Preferably the thickness is about 5 to about 100 μm. The adhesive film may further include a protective film to protect the adhesive layer, as necessary. The protective film may be separated when using the adhesive film.

Particular implementations of embodiments will now be described in the following Examples and Comparative Examples. It will be appreciated that these Examples are merely illustrative and are not to be construed as limiting the present invention thereto.

### EXAMPLES

The following components were used for Examples and Comparative Examples.

(a) Binder

i) Carboxyl Group-Modified Acrylonitrile Butadiene Rubber

Nipol N34 manufactured by Zone Co., Ltd. (in Japan) and having a weight-average molecular weight of 240,000

ii) (Meth)Acrylate-Based Copolymer

AOF 7001 manufactured by Aekyung Chemical Co., Ltd. (Korea) and having a weight-average molecular weight of 120,000

iii) Resin Having Ester Linkages in the Main Chain

iii-1) Ester type polyurethane resin: a polyurethane acrylate (weight-average molecular weight=25,000) was synthesized by polyaddition reaction of 60% of a polyol and hydroxymethacrylate/isophorone diisocyanate (0.5 mol/mol) in methyl ethyl ketone (50 vol. %) as a solvent in the presence of dibutyltin dilaurate as a catalyst at 1 atm and 90° C. for 5 hours. The polyol was synthesized by condensation of adipic acid and 1,4-butanediol and had ester linkages.

iii-2) Ether type polyurethane resin: polyurethane acrylate (weight-average molecular weight=25,000) was synthesized by polyaddition reaction of 60% polytetramethyleneglycol and hydroxy methacrylate/isoporon diisocyanate (0.5 mol/mol) in hydroxy methylethyl ketone (50 vol. %) as a solvent in the presence of dibutyltin dilaurate as a catalyst at 90° C. and 1 atm. for 5 hours.

iii-3) High Tg polyester resin: UE3200 (Tg: 65° C.) manufactured by UITIKA Co., Ltd. (Japan)

(b) Carbodiimide Group-Containing Compound

Stabaxol P200 manufactured by Rhein Chemie Co. Ltd. (Germany)

(c) (Meth)Acrylate Group-Containing Compound

The resultant compound obtained by blending isocyanuric acid ethylene oxide-modified diacrylate, bisphenol A propyleneoxide-modified diacrylate (weight-average molecular weight of 1,000) and acid phosphoxy ethyl methacrylate was used.

(d) Organic Peroxide

The resultant compound obtained by blending 1.8 parts by weight of lauroyl peroxide, with respect to 100 parts by weight of the binder, dissolved in toluene and having 10% solids and 0.9 parts by weight of benzoyl peroxide, with respect to 100 parts by weight of the binder, dissolved in toluene and having 10% solids, was used.

(e) Conductive Particles

Conductive particles were obtained by coating a divinylbenzene/styrene copolymer resin with gold and had an average particle diameter of 4 μm.

### Examples 1 to 4 and Comparative Examples 1 to 3

The respective components were blended according to the compositions as listed in Table 1 to prepare adhesive film compositions. Each of the prepared adhesive film compositions was left at room temperature for 1 hour, followed by sequential compression in provisional compression conditions of 160° C. and 1 second and main compression conditions of 180° C., 4 seconds, and 3.5 MPa using ITO (indium tin oxide) glass and COF (STEMCO Inc.) to measure an initial adhesive force and reliability. Example 4 was measured only with respect to the adhesive force. After measuring the initial adhesive force and reliability, adhesive force and connection resistance in a high-temperature and high-humidity atmosphere were measured under conditions of 85° C., a relative humidity of 85%, and 500 hours. Here, a 90-degree adhesive force was measured as the adhesive force and the connection resistance was measured using a 4-probe method. The measurement results are shown in Table 2.

TABLE 1

| | | | | | | | Comparative | | |
|---|---|---|---|---|---|---|---|---|---|
| | | | Example (E) | | | | Example (CE) | | |
| (unit: part by weight) | | | 1 | 2 | 3 | 4 | 1 | 2 | 3 |
| (a) | (i) Carboxyl group-modified | | 10 | 10 | 10 | 10 | 10 | 10 | 10 |
| | acrylonitrile butadiene rubber | | | | | | | | |
| | (ii) (Meth)acrylate-based copolymer | | 36 | 36 | 36 | 36 | 36 | 36 | 36 |
| | (iii) Resin having ester | iii-1) | 54 | 54 | 54 | 54 | 54 | — | — |
| | linkages in the main chain | iii-2) | — | — | — | — | — | 54 | — |
| | | iii-3) | — | — | — | — | — | — | 54 |

| | | | | | | | | |
|---|---|---|---|---|---|---|---|---|
| (b) | Carbodiimide group-containing | 1.8 | 5.4 | 9 | 1.8 | — | — | — |
| | compound | | | | | | | |
| (c) | Isocyanuric acid ethylene oxide- | 27 | 27 | 27 | 27 | 27 | 27 | 27 |
| | modified diacrylate | | | | | | | |
| | Bisphenol A propyleneoxide- | 48.6 | 45.1 | 41.4 | 48.6 | 50.5 | 45.1 | 50.5 |
| | modified diacrylate | | | | | | | |
| | Acid phosphoxy ethyl methacrylate | 1.8 | 1.8 | 1.8 | 1.8 | 1.8 | 1.8 | 1.8 |
| (d) | Organic peroxide | 2.7 | 2.7 | 2.7 | 2.7 | 2.7 | 2.7 | 2.7 |
| (e) | Conductive particles | 7.2 | 7.2 | 7.2 | — | 7.2 | 7.2 | 7.2 |

TABLE 2

| | | | E1 | E2 | E3 | E4 | CE1 | CE2 | CE3 |
|---|---|---|---|---|---|---|---|---|---|
| 180° C., | Initial | Adhesive | 910 | 885 | 865 | 930 | 940 | 790 | 980 |
| 4 sec., | | force | | | | | | | |
| 3.5 MPa | | (gf/cm²) | | | | | | | |
| | | Connection | 0.93 | 0.95 | 0.98 | — | 0.93 | 0.97 | 0.95 |
| | | resistance | | | | | | | |
| | | (Ω) | | | | | | | |
| | High | Adhesive | 890 | 870 | 865 | 905 | 530 | 630 | 570 |
| | temperature, | force | | | | | | | |
| | high | (gf/cm²) | | | | | | | |
| | humidity | Connection | 2.03 | 2.01 | 1.93 | — | 5.18 | 3.06 | 5.75 |
| | after 500 | resistance | | | | | | | |
| | hours | (Ω) | | | | | | | |

As can be seen from Table 2, for Examples 1 and 3, in which the carbodiimide group-containing compound was included in the adhesive film composition having ester linkages, not only the initial adhesive force but also the adhesive force and connection resistance in the high-temperature high-humidity atmosphere were good, thereby providing good reliability to the adhesive film. Example 4, in which the conductive particles were not used and the carbodiimide group-containing compound was included in the adhesive film composition, the adhesive force was not significantly lowered after reliability testing. On the other hand, for Comparative Example 1, in which the carbodiimide group-containing compound was not included in the adhesive film composition having ester linkages, the adhesive force was lowered and the connection resistance was increased in the high-temperature and high-humidity atmosphere. For Comparative Example 2, in which the adhesive film composition had ether linkages instead of the ester linkages, there were slight differences in terms of the initial adhesive force and the adhesive force and connection resistance in the high-temperature and high-humidity atmosphere, but the adhesive forces and the connection resistance were considerably lower than the adhesive film composition having the ester linkages.

For Comparative Example 3, in which the polyester resin having a high Tg was used, the initial adhesive force and connection resistance were similar to those of Examples 1 to 3, but the adhesive force was significantly lowered and the connection resistance was increased in the high-temperature and high-humidity atmosphere, thereby deteriorating reliability.

An adhesive film of an embodiment may be advantageously used between a semiconductor device of a CSP and a wiring board, e.g., an interposer. The adhesive film may reduce thermal stress. Film type adhesives may be used for a flexible printed wiring board or the like and may have an easy preparation process.

Typical film-type adhesives may generally include acrylonitrile butadiene rubber as a main composition. However, adhesive films including the acrylonitrile butadiene rubber as a main component may have significantly deteriorated adhesive strength or electric corrosion resistance after high temperature treatment for a long period of time. In particular, the film-type adhesives may undergo significant deterioration in moisture resistance testing under strict conditions, as in pressure cooker test (PCT) treatment used for reliability evaluation of semiconductor-related components.

An ester linkage-containing adhesive film may undergo hydrolysis of ester linkages in a high-temperature and high-humidity atmosphere. To prevent the hydrolysis of ester linkages, polyurethane may be polymerized with a polyether type polyol as a polymerization start material. Unlike these films, the adhesive film of an embodiment may exhibit stable physical properties after reliability testing as well as high adhesive strength by polyester linkages, thereby maintaining an initial adhesive force of the adhesive film. Further, when using a polyester resin of an embodiment to prevent or retard the hydrolysis of ester linkages, the hydrolysis of ester linkages may be prevented in a high-temperature and high-humidity atmosphere, thereby maintaining the adhesive strength and the physical properties.

An anisotropic conductive film may be produced by dispersing conductive particles in the film type adhesives as described above. When placing the anisotropic conductive film between target circuits, followed by heating and compression under certain conditions, circuit terminals may be electrically connected to each other through the conductive particles. In addition, a pitch between adjacent circuits may be filled with an insulating adhesive resin to allow the conductive particles to be independent of each other, thereby providing high insulation properties.

In an anisotropic conductive film of an embodiment including the binder including ester linkages, hydrolysis of ester linkages may be prevented. Thus, deterioration in adhesive force and connection resistance in the high-temperature high-humidity atmosphere may be avoided.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An adhesive film composition for electric and electronic devices, comprising:
a binder including an ester linkage-containing resin;
a carbodiimide group-containing compound;
a (meth)acrylate group-containing compound; and
an organic peroxide.

2. The adhesive film composition as claimed in claim 1, wherein the composition includes:
100 parts by weight of the binder,
about 0.1 to about 10 parts by weight of the carbodiimide group-containing compound,
about 10 to about 120 parts by weight of the (meth)acrylate group-containing compound, and
about 0.1 to about 10 parts by weight of the organic peroxide.

3. The adhesive film composition as claimed in claim 1, wherein the binder includes a carboxyl group-modified acrylonitrile butadiene rubber, a (meth)acrylate-based copolymer, and a resin having ester linkages in a main chain thereof.

4. The adhesive film composition as claimed in claim 3, wherein the binder includes, based on a total weight of the binder:
about 3 to about 60 wt % of the carboxyl group-modified acrylonitrile butadiene rubber,
about 5 to about 50 wt % of the (meth)acrylate-based copolymer, and
about 5 to about 70 wt % of the resin having ester linkages in the main chain thereof.

5. The adhesive film composition as claimed in claim 4, wherein:
the carboxyl group-modified acrylonitrile butadiene rubber has a weight-average molecular weight of about 2,000 to about 300,000,
the carboxyl group-modified acrylonitrile butadiene rubber includes about 10 to about 60 wt % acrylonitrile, based on a total weight of the carboxyl group-modified acrylonitrile butadiene rubber, and
the carboxyl group-modified acrylonitrile butadiene rubber includes about 1 to about 20 wt % of a carboxyl group, based on a total weight of the carboxyl group-modified acrylonitrile butadiene rubber.

6. The adhesive film composition as claimed in claim 4, wherein the (meth)acrylate-based copolymer includes a copolymer of at least one (meth)acrylate-based monomer, the (meth)acrylate-based monomer including at least one of hydroxyl group-containing (meth)acrylates, alkyl methyl(meth)acrylates, ethyl(meth)acrylates, propyl(meth)acrylates, butyl(meth)acrylates, hexyl(meth)acrylates, octyl(meth)acrylates, dodecyl(meth)acrylates, lauryl(meth)acrylates, (meth)acrylic acids, vinyl acetates, and derivatives thereof.

7. The adhesive film composition as claimed in claim 4, wherein the (meth)acrylate-based copolymer has a glass transition temperature (Tg) of about 50 to about 120° C. and an acid value of about 1 to about 100 mg KOH/g.

8. The adhesive film composition as claimed in claim 4, wherein the resin having ester linkages in the main chain thereof includes at least one of a polyester resin, an ester type urethane resin, a (meth)acrylate-modified urethane resin, and a reactive acrylate resin.

9. The adhesive film composition as claimed in claim 1, wherein the carbodiimide group-containing compound has a weight-average molecular weight of about 200 to about 600 and is represented by the following Chemical Formula 1:
R—N═C═N—R (1),
wherein each R is independently a C₁₋₆ straight or branched alkyl group, a C₅₋₁₀ chain type alkyl group, a C₆₋₂₀ aryl group, or a C₆₋₂₀ aralkyl group.

10. The adhesive film composition as claimed in claim 1, wherein the (meth)acrylate group-containing compound includes at least one of a (meth)acrylate oligomer and a (meth)acrylate monomer.

11. The adhesive film composition as claimed in claim 10, wherein the (meth)acrylate group-containing compound includes the (meth)acrylate oligomer, the (meth)acrylate oligomer including at least one of urethane-based (meth)acrylate oligomers, epoxy-based (meth)acrylate oligomers, polyester-based (meth)acrylate oligomers, fluorine-based (meth)acrylate oligomers, fluorene-based (meth)acrylate oligomers, silicone-based (meth)acrylate oligomers, phosphoric acid-based (meth)acrylate oligomers, maleimide-modified (meth)acrylate oligomers, and acrylate(meth)acrylate oligomers.

12. The adhesive film composition as claimed in claim 10, wherein the (meth)acrylate group-containing compound includes the (meth)acrylate monomer, the (meth)acrylate monomer including at least one of hydroxyl group-containing (meth)acrylates, C₁₋₂₀ straight alkyl(meth)acrylates, C₁₋₂₀ branched alkyl (meth)acrylates, C₆₋₂₀ aryl(meth)acrylates, C₆₋₂₀ arylalkyl(meth)acrylates, C₆₋₂₀ cycloalkyl-containing (meth)acrylates, polycyclic (meth)acrylates, heterocyclic (meth)acrylates, ether group-containing (meth)acrylates, epoxy group-containing (meth)acrylates, aryloxy group-containing (meth)acrylates, alkyleneglycol(meth)acrylates, bisphenol-A di(meth)acrylates, fluorene-based (meth)acrylates, and acid phosphoxy ethyl(meth)acrylates.

13. The adhesive film composition as claimed in claim 10, wherein the (meth)acrylate group-containing compound includes at least one of a fluorene-based epoxy(meth)acrylate and a fluorene-based urethane(meth)acrylate, the at least one fluorene-based epoxy(meth)acrylate and fluorene-based urethane(meth)acrylate being obtained from a fluorene derivative represented by the following Chemical Formula 2: 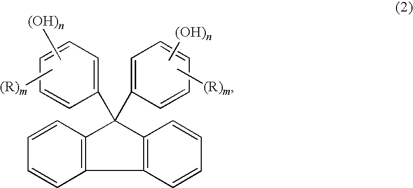
wherein each R is independently an alkyl group, an alkoxy group, an aryl group, or a cyclo-alkyl group, m is an integer of 0 to about 4, and n is an integer of about 2 to about 5.

14. The adhesive film composition as claimed in claim 1, further comprising:
about 0.1 to about 20 parts by weight of conductive particles with respect to 100 parts by weight of the binder.

15. The adhesive film composition as claimed in claim 14, wherein the conductive particles include at least one of:
metallic particles including at least one of Au, Ag, Ni, Cu, and Pb;
carbon particles;
metal-coated polymer resin particles; and
surface insulation-treated particles prepared through insulation treatment on a surface of a metal-coated polymer resin particle.

16. The adhesive film composition as claimed in claim 1, wherein the adhesive film composition has a 90-degree adhesive force, after a pressing condition of 180° C., 4 seconds, 3.5 MPa, of about 800 to about 980 gf/cm² at 85° C., a relative humidity of 85%, and 500 hours.

17. An adhesive film produced using the adhesive film composition as claimed in claim 1.
